(19) United States
(12) Patent Application Publication
(10) Pub. No.: US 2013/0151903 A1
(43) Pub. Date: Jun. 13, 2013

(54) IMAGE FORMING APPARATUS

(71) Applicant: SHARP KABUSHIKI KAISHA, Osaka (JP)

(72) Inventor: Hiroki KINOSHITA, Osaka (JP)

(73) Assignee: SHARP KABUSHIKI KAISHA, Osaka (JP)

(21) Appl. No.: 13/705,790

(22) Filed: Dec. 5, 2012

(30) Foreign Application Priority Data
Dec. 8, 2011 (JP) 2011-269163

(51) Int. Cl. G06F 11/22

(52) U.S. Cl. CPC G06F 11/2221
USPC 714/30

(57) ABSTRACT

An image forming apparatus has a plurality of device modules for executing predetermined functions; and a control module for controlling operation of the device modules. The control module comprises an initialization section for establishing a link; a master data transfer section for transferring data to a device module; and a link checking section for checking the state of the link. When a request for data transfer to a first device module out of the plurality of device modules is made, the link checking section checks the state of the link between the control module and the first device module. When the state of the link checked is determined to be abnormal, the initialization section establishes the link between the control module and the first device module, and then the master data transfer section transfers the data requested to be transferred to the first device module.

### CROSS-REFERENCE TO RELATED APPLICATION

This application is related to Japanese Patent Application No. 2011-269163 filed on Dec. 8, 2011, whose priority is claimed under 35 USC §119, and the disclosures of which are incorporated by reference in its entirety.

### BACKGROUND OF THE INVENTION

1. Field of the Invention

The present invention relates to an image forming apparatus. More particularly, the present invention relates to an image forming apparatus having a function of recovering a link established between modules for achieving functions of the image forming apparatus when an error occurs in the link.

2. Description of the Related Art

In image forming apparatuses such as digital copying machines and digital multi function printers (MFPs), parallel interfaces represented by PCI (Peripheral Component Interconnect) have been used as means for connecting devices such as CPU, image processing module and memory.

However, the parallel interfaces have some problems such as race conditions and clock skew, and transmission rates thereof are insufficient for use in high-speed and high-quality image forming apparatuses. It has been therefore recently proposed to use the PCI Express interface (hereinafter, referred to as PCIe), which is a high-speed serial interface, for image forming apparatuses.

PCIe is an international standard for interconnecting devices through a communication channel called link, for which the communication commands, register values and sequences are particularly specified by the PCI-SIG (Peripheral Component Interconnect Special Interest Group).

Data transfer between devices connected to the PCIe is executed by using bus commands. The bus commands are transferred by using four C/BE[3:0] signal lines of the signal lines for the PCIe.

Before write or read of image data, the link between the devices with the PCIe is established. For the establishment of the link, a configuration register (hereinafter, referred to as CONREG) in the device is set.

For example, between a control module for controlling operation of an entire image forming apparatus and an image processing module for executing image processing, initial setting of pieces of information included in the configuration register (CONREG) in the image processing module is performed according to a command transferred from the control module to the image processing module.

In the initial setting, initial values of a device ID for identifying the device, a status register for checking the current operation status of the device and a base address for identifying a connected device are mainly set and stored.

For the setting of the configuration register, a configuration transaction is generated separately from that for normal image data transfer processing.

Each device has a register for debugging purposes, and when an error occurs in data transfer through the PCIe, the error status is stored in the status register.

Japanese Unexamined Patent Application Publication No. 2008-225694 proposes an error analysis method comprising: storing an address of the destination of packets having an error in a debugging register; reproducing the same error to detect a transaction on the address stored; and identifying the source of the error.

In data transfer with conventional PCIe, occurrence of an error can be detected by checking information in the status register and the debugging register, and in case of an error, the configuration register is initialized again to establish a link for normal data transfer.

In some cases, however, values set in the configuration register (CONREG) of a device may be destroyed due to extrinsic noise such as static electricity on a signal line during data transfer.

In a certain case, for example, the values of the base address and the status register out of the values set in the CONREG may be overwritten to be different values from the initial values.

Since the conventional PCIe sequence does not have means for detecting destruction of an initial value, an established link itself may be broken and subsequent data communication may be precluded when an initial value in the CONREG is destroyed as described above.

In Japanese Unexamined Patent Application Publication No. 2008-225694, the error source can be identified, but there is no sequence for removing the error source. When an initial value in the CONREG is destroyed, therefore, the link is broken and data communication is precluded likewise.

As described above, when a value in the CONREG is destroyed and as a result a link is broken to preclude data communication in a conventional apparatus, there is no automated recovery means and therefore it is necessary to power up the apparatus again or reset the apparatus (manually press the reset button).

### SUMMARY OF THE INVENTION

The present invention provides an image forming apparatus capable of continuing data transfer between modules even when a link for the data transfer is broken due to extrinsic noise by reestablishing the link.

The present invention is an image forming apparatus comprising: a plurality of device modules for executing predetermined functions; and a control module for controlling operation of the device modules, the device modules and the control module being connected through a PCI Express interface, the control module comprising: an initialization section for establishing a link between the control module and each device module; a master data transfer section for transferring data requested to be transferred to a predetermined device module; and a link checking section for checking the state of the link between the control module and the device module, wherein when a request for data transfer to a first device module out of the plurality of device modules is made, the link checking section checks the state of the link between the control module and the first device module, and when the state of the link checked is determined to be abnormal, the initialization section establishes the link between the control module and the first device module, and then the master data transfer section transfers the data requested to be transferred to the first device module.

According to this configuration, the data are transferred after the establishment of the link when the state of the link is determined to be abnormal, and therefore the apparatus does not need to be restarted, and inoperativeness of the apparatus can be avoided.

### BRIEF DESCRIPTION OF THE DRAWINGS

FIG. 1 is a block diagram illustrating a configuration of exemplary modules connected to PCIe of an image forming apparatus of the present invention;

FIG. 2 is a flow chart of exemplary link initialization and link checking processing of the present invention;

FIG. 3 is an explanatory diagram showing exemplary bus commands to be transmitted and received through the PCIe of the present invention;

FIG. 4 is an explanatory diagram showing information in a configuration register of the present invention;

FIG. 5 is an explanatory diagram of an exemplary sequence of the link initialization process of the present invention; and

FIG. 6 is an explanatory diagram of an exemplary sequence of link checking and link reestablishment processing of the present invention.

### DESCRIPTION OF THE PREFERRED EMBODIMENTS

In the image forming apparatus, each of the plurality of device modules comprises: a slave data transfer section for transmitting data to and receiving data from the control module through the PCI Express interface; and a configuration register to be set when the link between the control module and the device module is established to store register information needed for the data transmission and reception.

In the image forming apparatus, the control module comprises a storage section for storing register initial values needed to establish the link between the control module and each device module, and the link checking section acquires, by means of the master data transfer section, the register information stored in the configuration register of the first device module, compares the register information acquired with the register initial values stored in the storage section, and determines the state of the link to be normal when the register information and the register initial values agree or determines the state of the link to be abnormal when the register information and the register initial values disagree.

In the image forming apparatus, the control module comprises a storage section for storing register initial values needed to establish the link between the control module and each device module, the initialization section transfers the register initial values for a second device module out of the plurality of device modules to the second device module in order to establish the link between the control module and the second device module, and the second device module stores the register initial values transferred thereto in its configuration register.

In the image forming apparatus, the register initial values stored in the storage section and the register information stored in each configuration register include a device ID for identifying the device module, a status register for showing the current status of the device module and a base address of the device module.

The present invention is a method for recovering a link in an image forming apparatus, the image forming apparatus comprising: a plurality of device modules for executing predetermined functions; and a control module for controlling operation of the device modules, the device modules and the control module being connected through a PCI Express interface, the control module comprising: an initialization section for establishing a link between the control module and each device module; a master data transfer section for transferring data requested to be transferred to a predetermined device module; a link checking section for checking the state of the link between the control module and the device module; and a storage section for storing register initial values needed to establish the link between the control module and each device module, each of the plurality of device modules comprising: a slave data transfer section for transmitting data to and receiving data from the master data transfer section of the control module through the PCI Express interface; and a configuration register to be set when the link between the control module and the device module is established to store register information needed for the data transmission and reception, wherein the initialization section transfers the register initial values stored in the storage section to a first device module out of the plurality of device modules in order to establish the link between the control module and the first device module, the first device module stores the register initial values transferred thereto in the configuration register to establish the link between the control module and the first device module, and then when a request for data transfer to the first device module is received by the control module, the link checking section transmits, by means of the master data transfer section, a command to the slave data transfer section of the first device module to request the register information stored in the configuration register of the first device module to be retrieved, the slave data transfer section of the first device module receives the command, retrieves the register information and transmits the register information retrieved to the master data transfer section, the link checking section acquires the register information received by the master data transfer section and compares the register information acquired with the register initial values stored in the storage section, and when the register information and the register initial values disagree, the link checking section determines the state of the link to be abnormal, the initialization section reestablishes the link between the control module and the first device module, and then the master data transfer section transfers the data requested to be transferred to the first device module.

According to the present invention, when a request for data transfer from the control module to the first device module is made, the link checking section checks the state of the link between the control module and the first device module, and the initialization section reestablishes the link when the state of the link is determined to be abnormal, and then the data requested to be transferred are transferred to the first device module. When the link is broken due to extrinsic noise such as static electricity, therefore, data transfer without the link established can be prevented to avoid a situation that the image forming apparatus becomes inoperative.

Hereinafter, the best mode for carrying out the present invention will be described with reference to the drawings. It should be noted that the present invention is not limited thereto.

### <Configuration of Image Forming Apparatus>

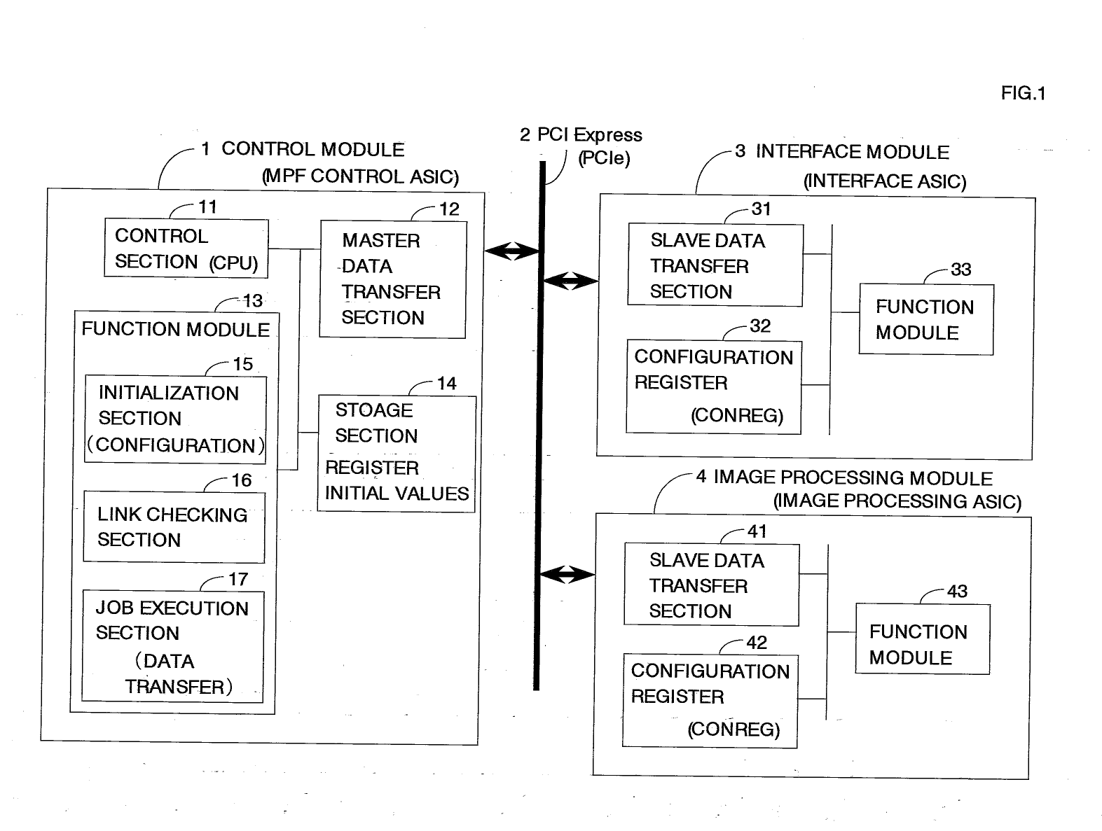

FIG. 1 is a block diagram illustrating a schematic configuration of exemplary modules forming an image forming apparatus of the present invention.

FIG. 1 is a block diagram mainly showing sections of the image forming apparatus for controlling operation of hardware to be used in image formation.

For example, the image forming apparatus of the present invention corresponds to a digital copying machine or a digital multi function printer (MFP), to which two-dimensional information including characters, figures, symbols and images are input, and which stores, processes and outputs onto paper sheets the two-dimensional information.

In the embodiment shown in FIG. 1, a control module 1, and an interface module 3 and an image processing module 4 are connected through a PCIe (Peripheral Component Interconnect Express) 2 interface. However, the number and the kinds of the modules are not limited thereto.

These modules can be provided mainly as ASICs and placed on a control board of an MFP, for example.

The PCIe interface is a standard of a data transmission line (bus) for interconnecting devices such as the ASICs and passing serial signals transmitted and received among the devices. As mentioned above, the PCIe is specified by the PCI-SIG

### (Peripheral Component Interconnect Special Interest Group).

The control module 1 is a section mainly composed of one MPF control ASIC and sends control commands to the other modules to control operation and stop of the other modules (device modules).

In FIG. 1, for example, the control module 1 transmits a data transfer command to the image processing module 4 through the PCIe, so that acquired image data are transferred to the image processing module and the image processing module performs image processing such as image compression. Hereinafter, the modules (3 and 4) other than the control module will be referred to as device modules. Each device module is a section for executing a predetermined function out of a plurality of functions to be achieved by the image forming apparatus.

The control module 1 mainly comprises a control section (CPU) 11, a master data transfer section 12, a function module 13 and a storage section 14, and executes a function preliminarily set as the function module 13.

The control section (CPU) 11 includes a ROM, a RAM, an I/O controller, a timer and the like, for example, and gets the hardware to work based on a control program preliminarily stored in the ROM or the like.

The function module 13 is a section for executing a function to be achieved by the image forming apparatus and composed of a logic circuit block of the hardware or a module of the control program.

As the function module 13, FIG. 1 shows an initialization section 15, a link checking section 16 and a job execution section 17, which constitute a function producing a characteristic of the present invention. In addition, the control module 1 may include other function modules.

The initialization section 15 performs processing for establishing links between the control module 1 and the other device modules (for example, the interface module 3 and the image processing module 4) connected through the PCIe 2.

The initialization section 15 performs processing for setting initial values in a configuration register (CONREG) in each device module (referred to as link initialization process or configuration) to be described later.

For example, the initialization section 15 transmits to the image processing module 4 a command for writing register initial values preliminarily stored in the storage section 14 into “device ID”, “status register”, “command register” and “base address” in the configuration register (CONREG) of the image processing module 4.

Thus, the register initial values of the desired device module are transferred to the device module in order to establish a link between the control module and the device module.

The link checking section 16 checks the state of the link between the control module 1 and a desired device module. That is, the link checking section 16 checks whether the link is being established normally.

When the state of the link is normal, it means that data such as transfer commands, data being transmitted and data being received can be transferred between the control module and the device module. When the state of the link is abnormal, it means that data such as transfer commands cannot be transferred between the control module and the device module.

The establishment of the link is checked (link checking process) by retrieving set values stored in the configuration register (CONREG) of the device module (hereinafter, also referred to as register information) and checking whether the set values (register information) retrieved and the register initial values preliminarily stored in the storage section 14 agree.

The present invention is characterized in that when an event of a job request occurs as a result of an input operation such as, for example, a copying operation by a user, the link checking process is performed on a device module to be involved in the event before a job such as data transfer to the device module is executed.

When the values in the register information retrieved and the initial values in the register agree in the link checking process, it is determined that the link is being established normally and data transfer corresponding to the job requested (job initiation process) is performed.

When they disagree, however, the state of the link is determined to be abnormal, and the initialization section 15 performs the link initialization process (configuration) again to establish the link between the control module and the device module having an abnormal value, and then the master data transfer section transfers the data requested to be transferred to the device module.

The job execution section 17 executes a job requested. For example, the job execution section 17 performs processing for transferring image data scanned in a copying operation to the interface module 3.

Jobs to be executed differ depending on functions preliminarily provided to the image forming apparatus of the present invention.

The master data transfer section 12 transfers data requested to be transferred to a predetermined device module. Specifically, the master data transfer section 12 performs read and write of digital signals on the PCIe 2. The data transfer section included in the control module 1 is also referred to as PCIe master module.

Slave data transfer sections included in the device modules perform transmission and reception of data on the control module 1 through the PCIe interface. They are referred to as PCIe slave modules.

The storage section 14 mainly stores the register initial values preliminarily. The register initial values are information needed for establishing the link between the control module and each of the device modules, and stored for each device module separately.

The storage section 14 also stores other information such as data and commands transferred between the master module and the slave modules.

As the storage section 14, a nonvolatile memory such as ROM is used for storing data which should be stored even after power-off such as, for example, the register initial values, and a rewritable memory such as RAM is used for storing data which are temporarily stored during data transfer and which can be erased after power-off.

As illustrated in FIG. 1, the device modules such as the interface module 3 and the image processing module 4 mainly include the slave data transfer sections (31 and 41), the configuration registers (CONREGs, 32 and 42) and function modules (33 and 43), respectively.

The device modules are sections for receiving request commands transmitted from the control module 1 and executing their function modules preliminarily provided as functions of the devices.

The interface module 3 is achieved by an interface ASIC including one or more function modules 33 and executes a USB function and an Ethernet® function, for example.

The image processing module 4 is achieved by an image processing ASIC including one or more function modules 43 and executes an image editing (enlargement, reduction, rotation) function and a color correction function, for example.

The slave data transfer sections (31 and 41) perform read and write of digital signals on the PCIe 2 as in the case of the master data transfer section 12, and, as mentioned above, they are referred to as PCIe slave modules as being included in the device modules that work in response to request commands from the control module 1.

The configuration registers (CONREGs) 32 and 42 are sections for storing information necessary for establishing the links between the control module and the device modules, and information needed for transmitting and receiving data necessary for operation of the device modules through the PCIe, as mentioned above. The values in the CONREGs are set when the links are established between the control module and the device modules.

As the configuration registers (CONREGs), RAM may be used for temporarily storing information. They may be provided in each slave data transfer section (slave module) as a logic element.

The function modules (33 and 43) represent functions to be executed by the device modules. Each of them may be composed of a hardware logic circuit or may be achieved by a control program on ROM.

When the function module of each device module is achieved by the control program, the module is not bussed to the other components as shown in FIG. 1, and the function is achieved by operating the hardware logic in the ASIC based on the control program.

The register information to be set in the configuration registers (CONREGs) is determined by the PCIe specifications.

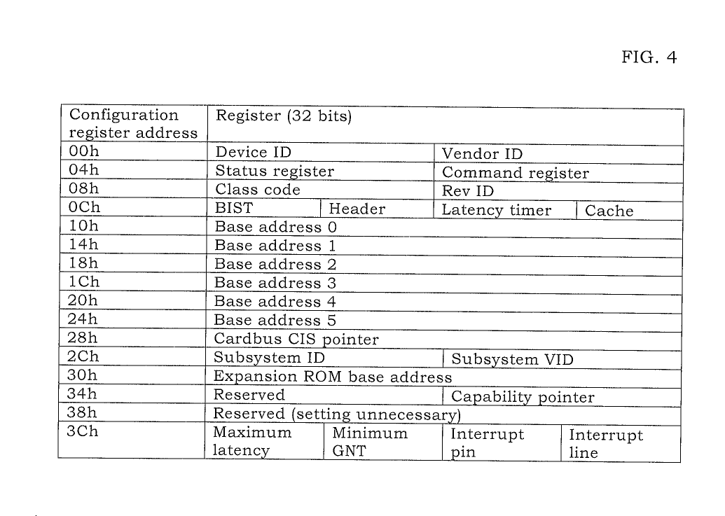

FIG. 4 is an explanatory diagram showing the information in the configuration registers (CONREGs) determined by the PCIe specifications.

Each CONREG has an address region 00H to 3CH, and each piece of the register information is assigned a region having a predetermined number of bytes.

For example, the status register which shows the current status of the device module is stored in an address region 04H and 05H as two bytes of data.

The base addresses of the device module are stored in address regions 10H to 27H as 24 bytes of data.

The device ID for identifying the device module is stored in an address region 02H and 03H as two bytes of data.

Hereinafter, each piece of the register information will be roughly described.

### Description of Register Information

Vendor ID (offset 00h-01h, 2 bytes)

A region for specifying the device manufacturer. The ID is assigned by the PCI-SIG.
Device ID (offset 02h-03h, 2 bytes)

A region for specifying the device. The ID is assigned under the management of the device manufacturer.
Command (offset 04h-05h, 2 bytes)

Control functions associated with the device are assigned to each bit.
Status (offset 06h-07h, 2 bytes)

The statuses (error conditions and the like) associated with the device are assigned to each bit.
Rev ID (offset 08h, 1 byte)

A region for specifying a device-specific revision number. The ID is assigned by the device manufacturer.
Class code (offset 09h-0Bh, 3 bytes)

Classifications of function classes defined by the PCI-SIG are shown.
Cache memory size (offset 0Ch, 1 byte)

The cache line size to be a cache memory block control unit is set.
Master latency timer (offset 0Dh, 1 byte)

The latency timer setting is unaffected in the PCI Express device. This register is fixedly set to 00h.
Header type (offset 0Eh, 1 byte)

The header format type after offset 10h is specified, and whether the device is multifunction is shown.
BIST (offset 0Fh, 1 byte)

A register for controlling the self test function on startup. 0x00 is set for normal operation.
Capability pointer (offset 34h, 1 byte)

An address pointer where a new device-specific capability list exists is shown. This register is effective only when status bits 4 are enable.
Interrupt line (offset 3Dh, 1 byte)

A register for storing routine section information of an interrupt signal line, which is used only by BIOS, PCI bus driver and OS. Device driver and hardware is never affected by the value.
Interrupt pin (offset 3Dh, 1 byte)

Four interrupt signal lines (INTA-INTD) can be used. Which signal line is used by the device is shown.
Base address register (offset 10h-27h, 24 bytes)

A register for setting an address to map a register and a memory buffer of the PCI device between memory space and I/O space of the CPU.
Cardbus CIS pointer (offset 28h-2Bh, 4 bytes)

A starting address of the CIS (Card Information Structure) of the Cardbus card is shown.
Subsystem vendor ID (offset 2Ch-2Dh, 2 bytes)

An ID number defining a vendor who designed an add-in card is shown.
Subsystem ID (offset 2Eh-2Fh, 2 bytes)

A system definition ID defined by a vendor who designed an add-in card is shown. The ID depends on the vendor.
Expansion ROM base address (offset 30h-33h, 4 bytes)

Address space to be used by expansion ROM implemented in an add-in card to be added to the PCIe is shown.
Minimum GNT (offset 3Eh, 1 byte)

The setting of the minimum GNT does not have any effect in the PCI Express device, and the register is fixed at 00h.
Maximum latency (offset 3Fh, 1 byte)

The setting of the maximum latency does not have any effect in the PCI Express device, and the register is fixed at 00h.

Hereinafter, specific examples of the values to be set in the configuration registers (CONREGs) will be shown.

For example, the following values are set as the configuration values.

| | |
|---|---|
| Address 00h | Device ID = 0x 1014, Vendor ID = 0x13bd |
| Address 04h | Status register = 0x0000, |
| | Command register = 0x0007 |
| Address 08h | Class code = 0x0001, RevID = 0x0580 |
| Address 0Ch | BIST = 0x00, Header = 0x00, Latency timer = 0x00, |
| | Cache = 0x20 |
| Address 10h | Base address 0 = −0x60000000 |
| Address 14h | Base address 1 = 0x E0000000 |
| Address 18h | Base address 2 = 0xFFFFFFFF |
| Address 1Ch | Base address 3 = 0x00000000 |
| Address 20h | Base address 4 = 0x00000000 |
| Address 24h | Base address 5 = 0x00000000 |
| Address 28h | CIS card pointer = 0x00000000 |
| Address 2Ch | Subsystem ID = 0x00000000, |
| | Subsystem VID = 0x13bd |
| Address 30h | Expansion ROM base address = 0x00000000, |
| Address 34h | Capability pointer = 0x00000000] |
| Address 3Ch | Maximal latency = 0x0004, Minimum GNT = 0x0000, |
| | Interrupt pin = 0x0001, Interrupt line = 0x0000 |

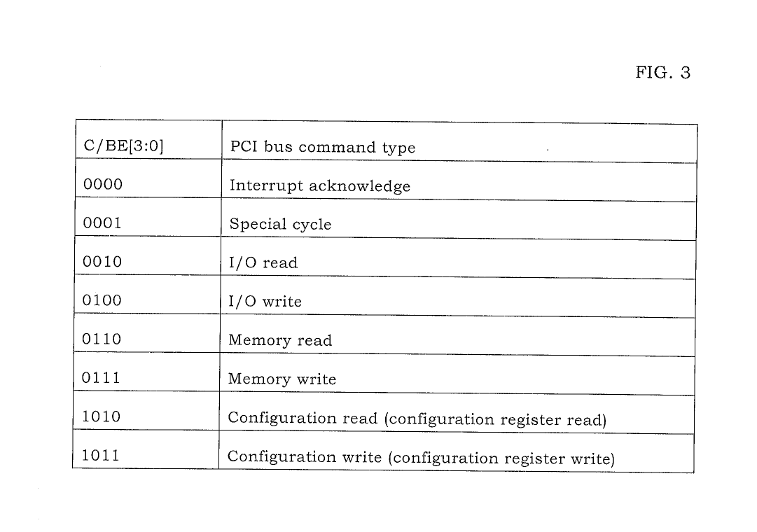

FIG. 3 is an explanatory diagram showing exemplary bus commands to be transmitted and received through the PCIe.

Data are transferred between the control module 1 and the device module (3 or 4) by using the bus commands.

When the link initialization is performed on the image processing module 4, for example, 1011 (configuration write) is transmitted from the control module 1 to the image processing module 4 as a bus command, and the register initial values preliminarily stored in the storage section 14 are written into the configuration register 42 of the image processing module 4.

When the link checking section 16 retrieves the information in the configuration register 42 of the image processing module 4, 1010 (configuration read) is transmitted from the control module 1 to the image processing module 4 as a bus command.

Receiving the bus command, the image processing module 4 retrieves the information in the configuration register (CONREG) 42 and transfers the information retrieved to the control module 1.

### <Link Initialization Process and Data Transfer Process of Present Invention>

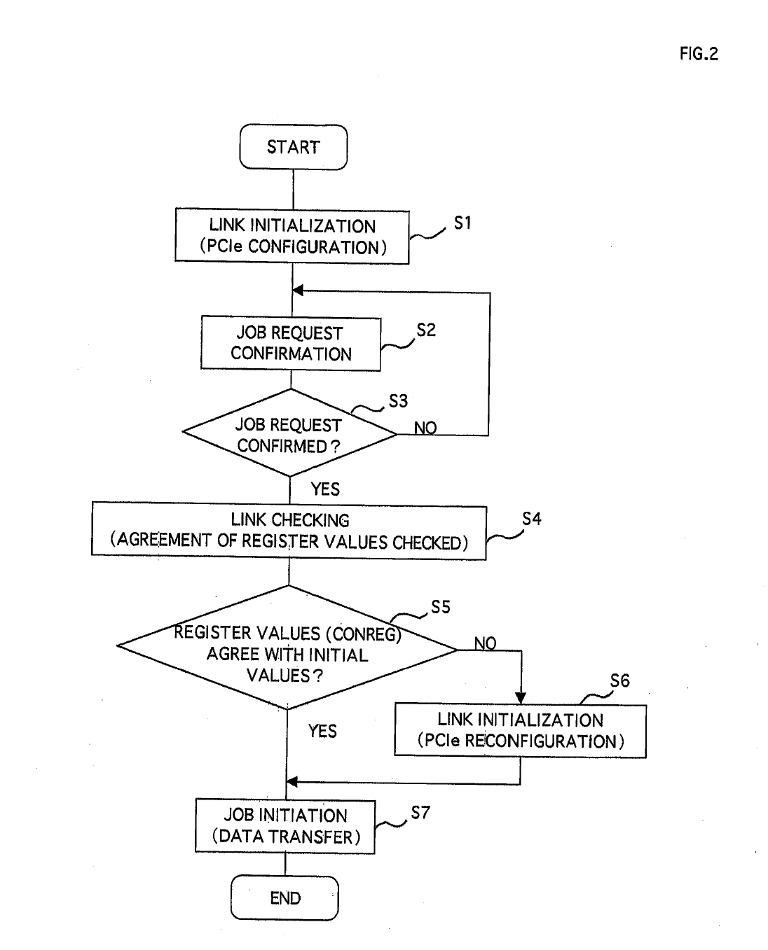

FIG. 2 is a flow chart of exemplary link initialization and link checking processing of the present invention.

Generally, when the power of the image forming apparatus of the present invention is turned on, an initialization process for establishing links through the PCIe between the control module 1 and the device modules (3 and 4) is performed.

After the link establishment, predetermined data transfer is executed between the control module 1 and the device module s with the links established.

When a certain job is requested after the link establishment by the initialization in the present invention, the job is not started immediately, but the link checking process is performed first to confirm that the relevant link is in a normal state, and then the job is started.

That is, in the present invention, when a user performs a copying, printing or scanning operation and in response a predetermined job corresponding to the operation is to be executed in an image forming apparatus such as an MFP, the state of the link of the device module is checked before the job is actually executed. When the link is not being established, the link initialization is performed again (reconfiguration), and therefore data transfer without the link established can be prevented to avoid a situation that the image forming apparatus becomes inoperative.

Hereinafter, processing including the link initialization will be explained based on the flow chart in FIG. 2.

First, the power of the image forming apparatus is turned on, and then the CPU 11 of the control module 1 executes the link initialization process (PCIe configuration) in step S1.

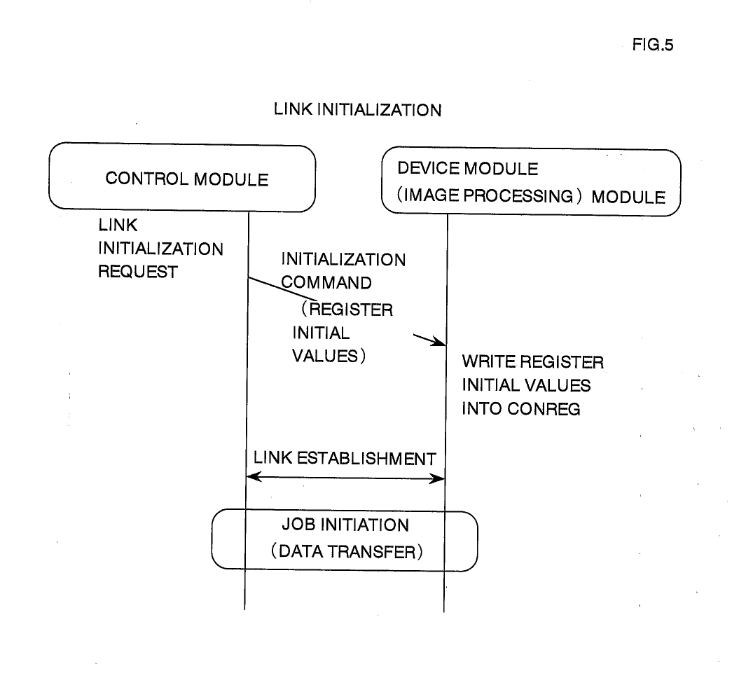

FIG. 5 is an explanatory diagram of an exemplary sequence of the link initialization process.

Here, in order to establish a link between the control module 1 and each of the device modules represented by the interface module 3 and the image processing module 4, the CPU 11 retrieves the register initial values preliminarily stored in the storage section 14, and the master data transfer section 12 transmits an initialization command including the register initial values retrieved to the slave data transfer section of the device module for which the link is to be established.

This command is sent out onto the PCIe from the master data transfer section 12 by generating a configuration transaction on the PCIe unlike transfer (read and write) processes of actual job data such as image data.

Here, the configuration transaction refers to configuration register read/write with the connected device, whereas the actual data transfer process is performed by IO read/write and memory read/write. Thus, they are different in the data transfer format.

When the slave data transfer section 31 receives this command, the register initial values included in the command are written into the configuration register (CONREG).

That is, each piece of information of the register initial values transferred is stored in each corresponding address in the configuration register as shown in FIG. 4. As a result, the initial setting of the device ID, the base addresses, and so on is completed, thereby establishing a link with the PCIe.

Thereafter, data such as image data can be transferred between the control module 1 and the device module (3 or 4) for which the initial setting in the CONREG is completed.

In step S2, the CPU 11 checks whether a job request is input by an input operation by a user.

For example, when the user presses a specific key for a copying operation, the CPU 11 detects the interrupt input for the copying operation and confirms that the job for the copy process has been requested.

When the job request is confirmed in step S3, the processing then proceeds to step S4. When the job request is not confirmed in step S3, the processing then goes back to step S2.

In step S4, the CPU 11 performs the link checking process.

Since the module which processes the job requested is preliminarily determined, the device module to be involved in the job request is specified, that is, it is determined for which device module the link should be checked.

In the link checking process, values of the register information stored in the configuration register (CONREG) of the device module (3 or 4) are retrieved, and the values of the register information retrieved and the register initial values stored in the storage section 14 are compared to check whether or not they agree.

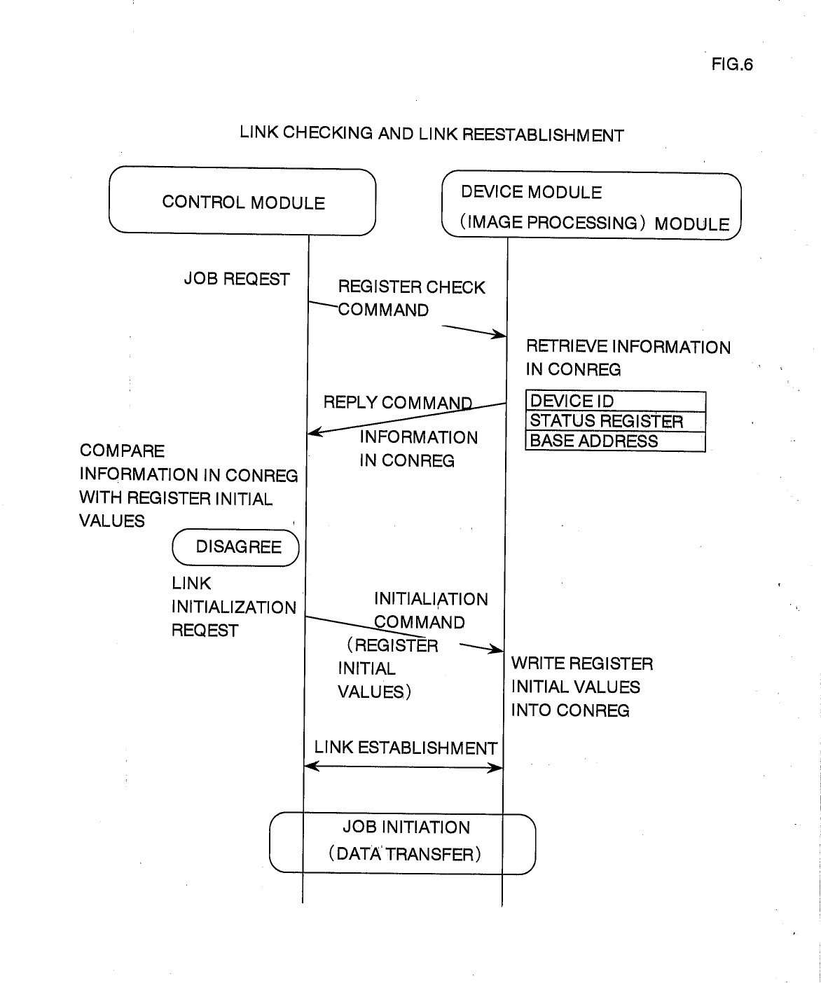

FIG. 6 is an explanatory diagram of an exemplary sequence of the link checking process.

In the link checking process, the CPU 11 first instructs the master data transfer section 12 to transmit a register check command to the slave data transfer section (31 or 41) of the device module (3 or 4) for which the link should be checked.

The master data transfer section 12 instructed so transmits, through the PCIe, the register check command to the slave data transfer section of the device module for which the link should be checked.

The slave data transfer section receives the command, retrieves the register information stored in the configuration register (CONREG), and then transmits a reply command including the register information in the CONREG retrieved to the master data transfer section 12 through the PCIe.

The master data transfer section 12 receives the reply command, and then acquires the register information included in the reply command. Then, the register information in the CONREG acquired and the register initial values stored in the storage section 14 are compared.

As the comparison, all the values of the register information in the CONREG as shown in FIG. 4 and all their corresponding register initial values may be checked to see whether they all agree.

Alternatively, only some important values may be checked to see whether they agree.

For example, out of the values of the register information in the CONREG, only the device ID, the status register and the base addresses may be checked to see whether they agree with their corresponding register initial values.

When at least one of the values of the register information checked disagrees with its corresponding register initial value in the comparison, the state of the link is determined to be abnormal (broken).

On the other hand, when all the values of the register information checked agree with their corresponding register initial values, the state of the link is determined to be normal.

After the link checking process in step S4, the processing proceeds to step S7 when all the values of the register information in the CONREG checked agree with their corresponding register initial values in step S5, and the processing proceeds to step S6 when at least one value of the register information in the CONREG checked disagrees with its corresponding register initial value.

In step S6, the PCIe configuration is performed again. This process is the same as the link initialization process in step S1.

This process causes the control module 1 to transfer the correct register initial values to the device module with the abnormal link, and the correct values are written into the CONREG of the device module.

Thereby, the link between the control module 1 and the device module with the abnormal link is recovered.

After the recovery of the link, therefore, data such as image data can be transferred between the two modules.

After step S6, the processing proceeds to step S7.

In step S7, the job confirmed in step S2 is started, and data transfer between the modules is executed.

For example, when a job on the image processing module 4 is requested, the CPU 11 transmits IO write/read commands or memory write/read commands to the image processing ASIC through the PCIe to start the job, and then the job requested is executed.

When the data transfer process according to the job request is finished, the processing is completed.

1. An image forming apparatus comprising:
a plurality of device modules for executing predetermined functions; and
a control module for controlling operation of the device modules, the device modules and the control module being connected through a PCI Express interface,
the control module comprising:
an initialization section for establishing a link between the control module and each device module;
a master data transfer section for transferring data requested to be transferred to a predetermined device module; and
a link checking section for checking the state of the link between the control module and the device module, wherein
when a request for data transfer to a first device module out of the plurality of device modules is made,
the link checking section checks the state of the link between the control module and the first device module, and
when the state of the link checked is determined to be abnormal,
the initialization section establishes the link between the control module and the first device module, and then
the master data transfer section transfers the data requested to be transferred to the first device module.

2. The image forming apparatus according to claim 1, wherein each of the plurality of device modules comprises:
a slave data transfer section for transmitting data to and receiving data from the control module through the PCI Express interface; and
a configuration register to be set when the link between the control module and the device module is established to store register information needed for the data transmission and reception.

3. The image forming apparatus according to claim 2, wherein
the control module comprises a storage section for storing register initial values needed to establish the link between the control module and each device module, and
the link checking section acquires, by means of the master data transfer section, the register information stored in the configuration register of the first device module,
compares the register information acquired with the register initial values stored in the storage section, and
determines the state of the link to be normal when the register information and the register initial values agree or determines the state of the link to be abnormal when the register information and the register initial values disagree.

4. The image forming apparatus according to claim 2, wherein
the control module comprises a storage section for storing register initial values needed to establish the link between the control module and each device module,
the initialization section transfers the register initial values for a second device module out of the plurality of device modules to the second device module in order to establish the link between the control module and the second device module, and
the second device module stores the register initial values transferred thereto in its configuration register.

5. The image forming apparatus according to claim 3,
the register initial values stored in the storage section and the register information stored in each configuration register include a device ID for identifying the device module, a status register for showing the current status of the device module and a base address of the device module.

6. The image forming apparatus according to claim 4, wherein
the register initial values stored in the storage section and the register information stored in each configuration register include a device ID for identifying the device module, a status register for showing the current status of the device module and a base address of the device module.
